(19) United States
(12) Patent Application Publication
(10) Pub. No.: US 2025/0381702 A1
(43) Pub. Date: Dec. 18, 2025

(54) CHAINSAW WITH WEIGHT REDUCTION FEATURES

(71) Applicant: Milwaukee Electric Tool Corporation, Brookfield, WI (US)

(72) Inventor: Mark Hughes, Brookfield, WI (US)

(21) Appl. No.: 19/233,270

(22) Filed: Jun. 10, 2025

Related U.S. Application Data
(60) Provisional application No. 63/659,625, filed on Jun. 13, 2024.

(51) Int. Cl. B27B 17/12; B27B 17/00; B27B 17/02; H01M 50/247

(52) U.S. Cl. CPC B27B 17/12; B27B 17/0008; B27B 17/02; H01M 50/247; H01M 2220/30

(57) ABSTRACT

A chainsaw includes a housing, a guide bar, a chain, and a motive device. The housing includes a rigid chassis and one or more shell panels attached to the rigid chassis. The housing defines an interior between the rigid chassis and the one or more shell panels. The guide bar is attached to the housing. The guide bar includes an outer track. The chain is movably coupled to the outer track. The motive device is operable to move the chain relative to the guide bar. The motive device is supported on the rigid chassis within the interior.

### CROSS REFERENCE TO RELATED APPLICATIONS

The present application claims priority to 63/659,625 filed on Jun. 13, 2024, the disclosure of which is incorporated by reference herein in its entirety.

### FIELD

The present disclosure relates generally to outdoor power tools, such as chainsaws.

### BACKGROUND

Outdoor power tools such as chainsaws utilize a moving chain with teeth to cut into material, such as wood. The teeth are driven along an outer path of a guide bar in a continuous manner by a driving element. The driving element is controlled by a trigger located on a handle of the chainsaw. As the operator engages the trigger, the speed of the driving element changes, resulting in operation of the chainsaw.

Recently, battery powered outdoor power tools have increased in popularity. However, chainsaw weight is a frequent issue.

Accordingly, improvements which address the above-described issues are desired in the art and would be advantageous.

### BRIEF DESCRIPTION

Aspects and advantages of the present disclosure will be set forth in part in the following description, or may be obvious from the description, or may be learned through practice of the technology.

In accordance with one embodiment, a chainsaw is provided. The chainsaw may include a housing, a guide bar, a chain, and a motive device. The housing may include a rigid chassis and one or more shell panels attached to the rigid chassis. The housing may define an interior between the rigid chassis and the one or more shell panels. The guide bar may be attached to the housing. The guide bar may include an outer track. The chain may be movably coupled to the outer track. The motive device may be operable to move the chain relative to the guide bar. The motive device may be supported on the rigid chassis within the interior.

In accordance with another embodiment, a chainsaw is provided. The chainsaw may include a housing, a guide bar, a chain, a motive device, and a control board. The housing may include a rigid chassis and one or more shell panels attached to the rigid chassis. The housing may define an interior between the rigid chassis and the one or more shell panels. The guide bar may be attached to the housing, the guide bar may include an outer track. The chain may be movably coupled to the outer track. The motive device may be operable to move the chain relative to the guide bar. The motive device may be supported on the rigid chassis within the interior. The control board may be supported on the rigid chassis rearward from the motive device. The rigid chassis may further include a plurality of heat-sink fins defining one or more air channels extending downward and toward the motive device from a channel inlet to a channel outlet.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1 provides a perspective view of a chainsaw in accordance with embodiments of the present disclosure;

FIG. 2 provides a perspective view of a portion of a chainsaw in accordance with embodiments of the present disclosure;

FIG. 3 provides an exploded perspective view of a main body assembly of the exemplary chainsaw of FIG. 2;

FIG. 4 provides an elevation view of the exemplary chainsaw of FIG. 3;

FIG. 5 provides another elevation view of the exemplary chainsaw of FIG. 3;

FIG. 6 provides an elevation view of the exemplary chainsaw of FIG. 3, wherein a portion of the housing has been removed for clarity;

FIG. 7 provides a magnified elevation view of a portion of the exemplary chainsaw of FIG. 3, wherein a portion of the housing has been removed for clarity;

FIG. 8 provides a perspective view of a portion of the exemplary chainsaw of FIG. 3;

FIG. 9 provides a magnified sectional view of a portion of a chainsaw in accordance with embodiments of the present disclosure;

FIG. 10 provides a perspective view of a chassis core of a chainsaw in accordance with embodiments of the present disclosure;

FIG. 11 provides another perspective view of a chassis core of a chainsaw in accordance with embodiments of the present disclosure;

FIG. 12 provides a perspective view of a chassis core of a chainsaw in accordance with embodiments of the present disclosure;

FIG. 13 provides another perspective view of a chassis core of a chainsaw in accordance with embodiments of the present disclosure;

FIG. 14 provides a perspective view of a rigid chassis of a chainsaw in accordance with embodiments of the present disclosure;

FIG. 15 provides a perspective view of an oil tank and shroud of a chainsaw in accordance with embodiments of the present disclosure;

FIG. 16 provides a perspective of view of an oil pump and rigid chassis of a chainsaw in accordance with embodiments the present disclosure;

FIG. 17 provides a perspective view of an oil pump of a chainsaw in accordance with embodiments of the present disclosure;

FIG. 18 provides a perspective view of a main housing assembly of a chainsaw in accordance with embodiments of the present disclosure;

FIG. 19 provides a perspective view of the exemplary main housing assembly of FIG. 18, wherein a portion has been removed for clarity;

FIG. 20 provides a perspective view of a rigid chassis and shell panel of a chainsaw in accordance with embodiments of the present disclosure;

FIG. 21 provides another perspective view of the exemplary rigid chassis and shell panel of FIG. 20;

FIG. 22 provides a perspective view of a main housing assembly of a chainsaw in accordance with embodiments of the present disclosure;

FIG. 23 provides a perspective view of the exemplary main housing assembly of FIG. 22, wherein a portion has been removed for clarity;

FIG. 24 provides a perspective view of the chassis core of the exemplary main housing assembly of FIG. 22; and

FIG. 25 provides another perspective view of the chassis core of the exemplary main housing assembly of FIG. 22.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first,” “second,” and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counterclockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, the present disclosure is directed to chainsaws which address one or more of the above-identified issues. More specifically, chainsaws in accordance with the present disclosure may advantageously provide improved weight attributes, such as a weight-to-power ratio, while also having improved ergonomics which facilitate more efficient, comfortable use.

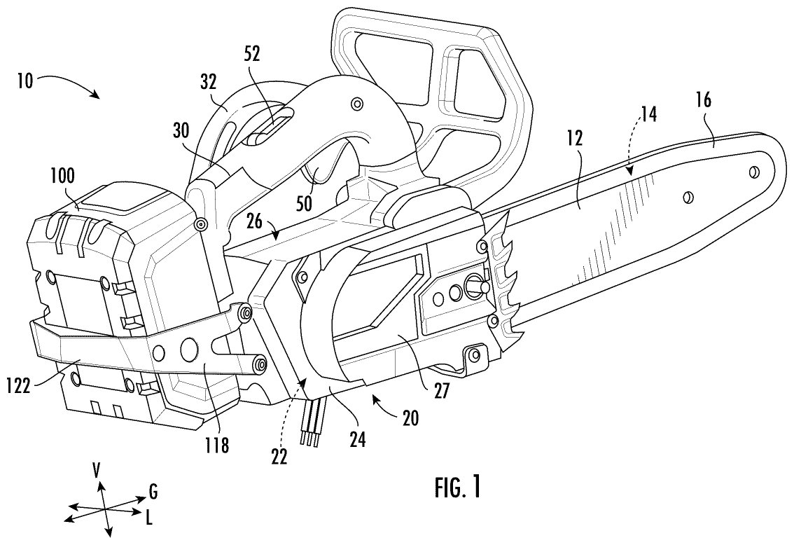

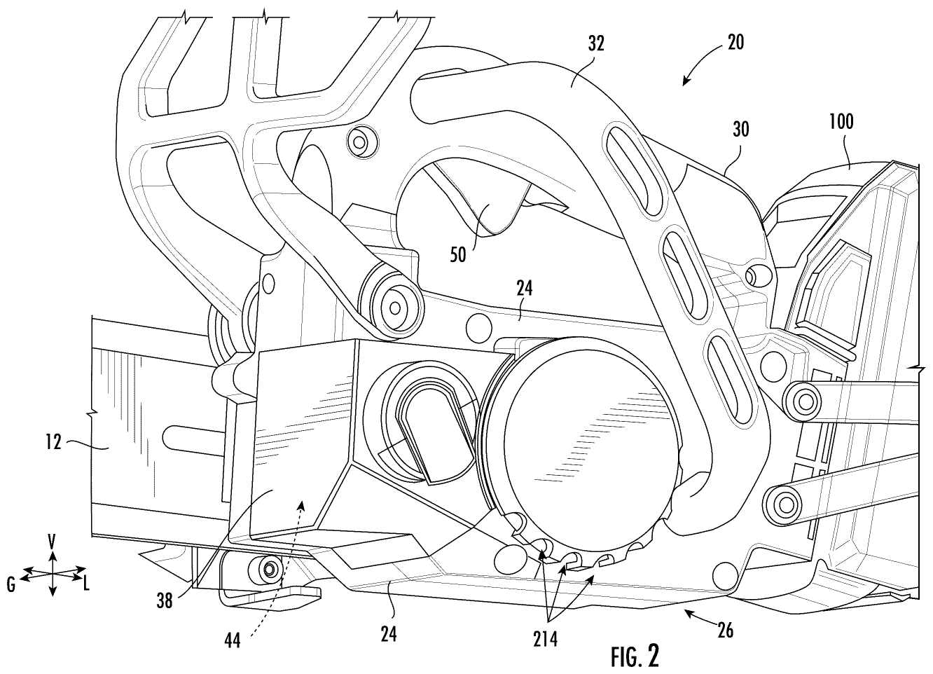

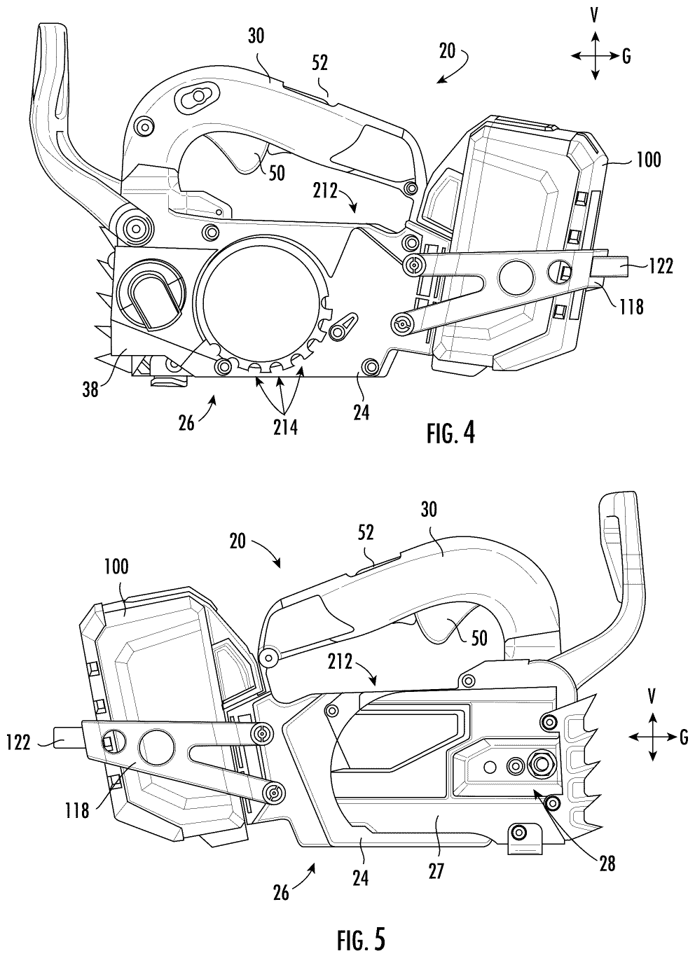

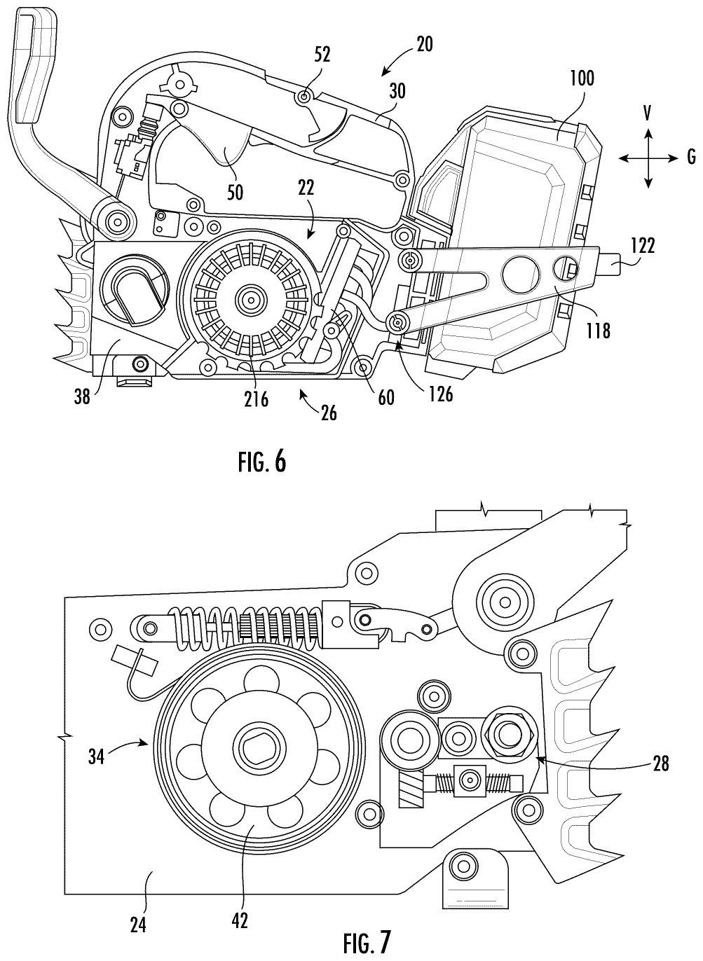

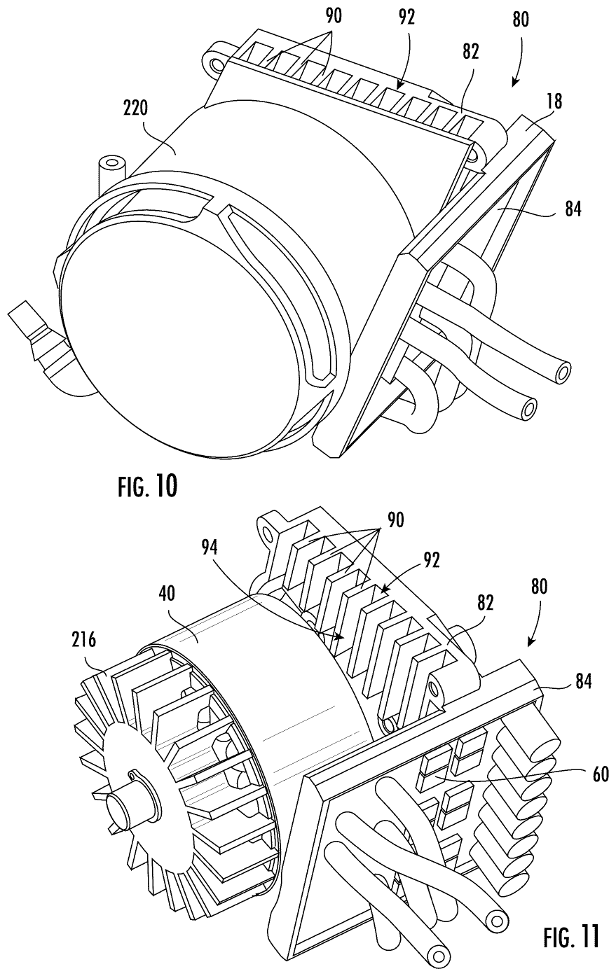

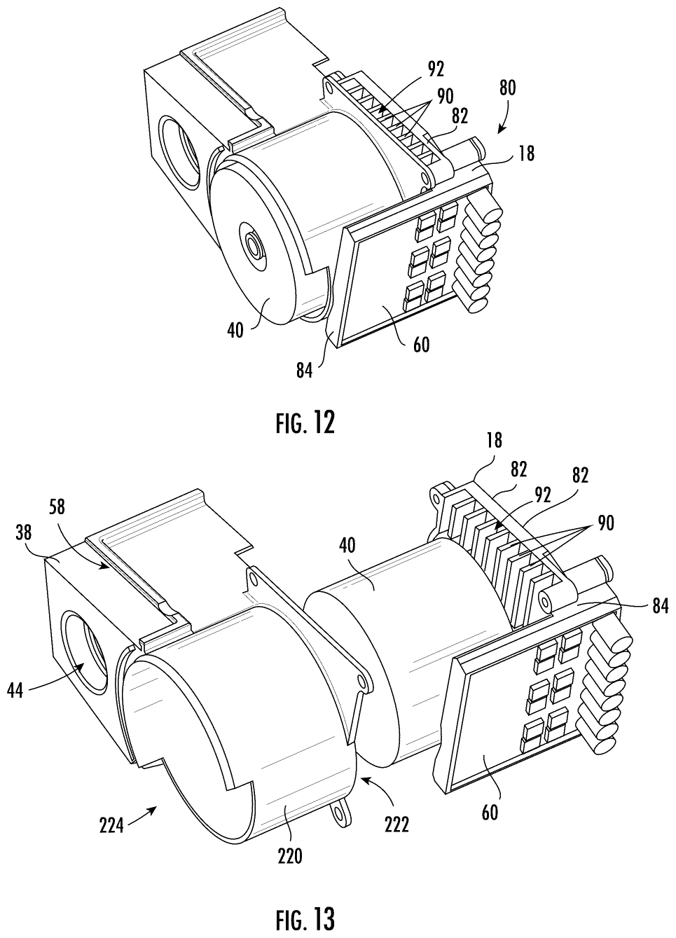

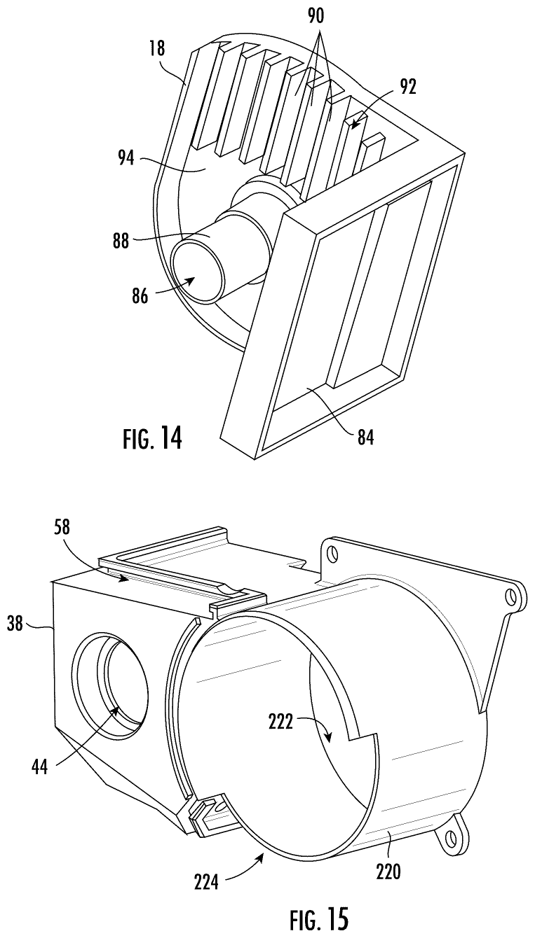

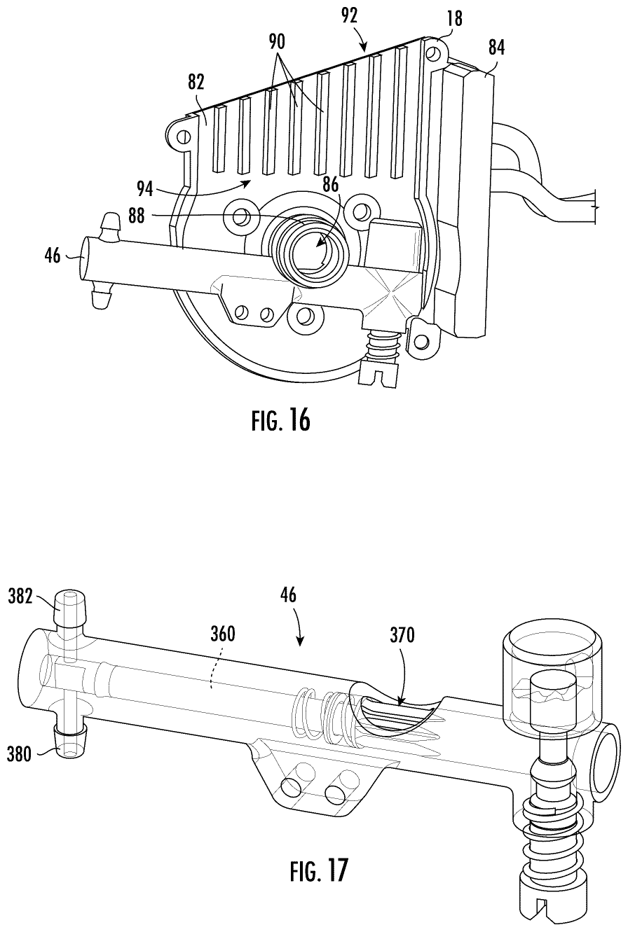

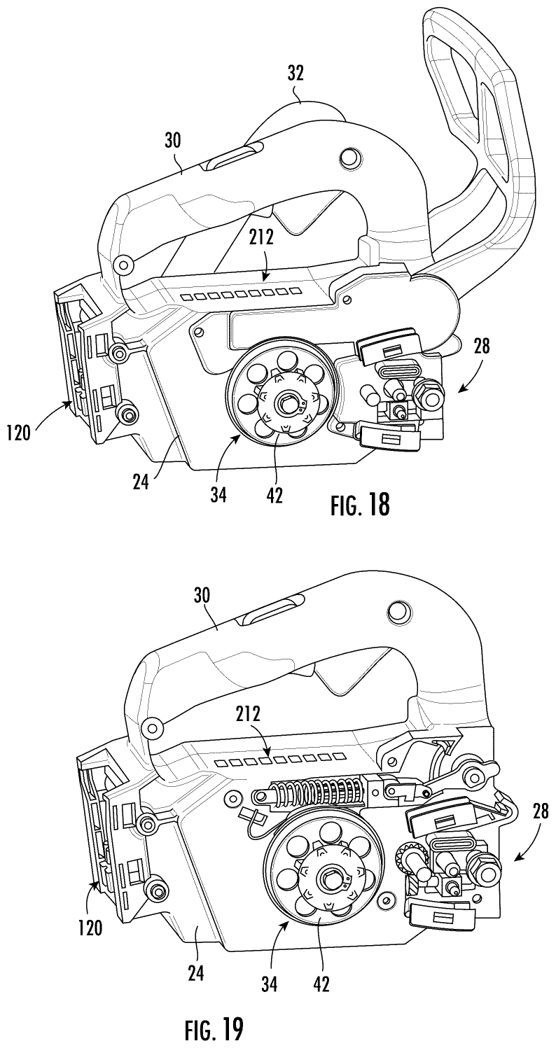

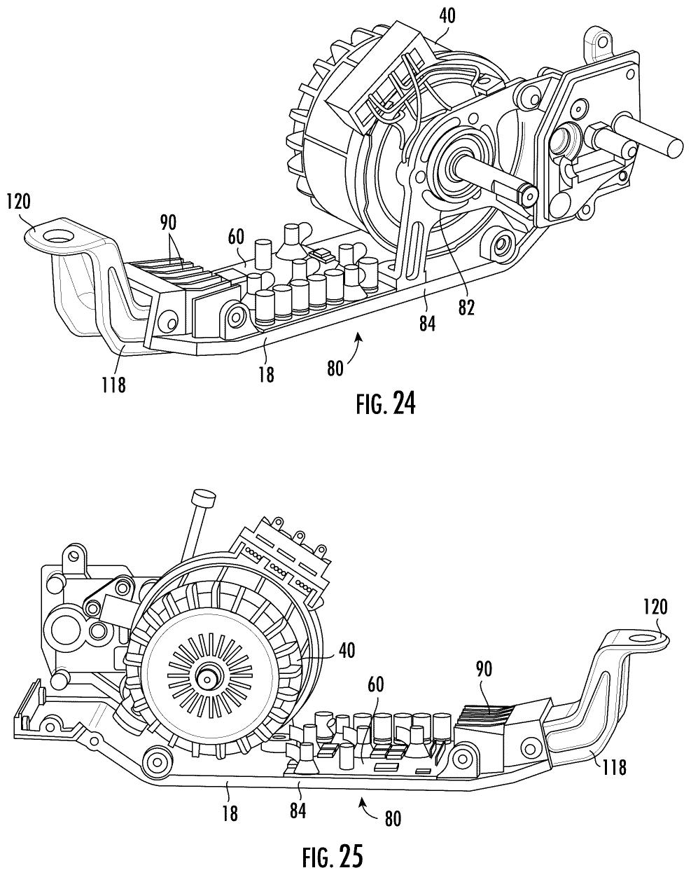

Referring now to the drawings, FIGS. 1 through 25 illustrates various aspects and embodiments of the present disclosure. In particular, chainsaws 10 in accordance with embodiments of the present disclosure are provided. A chainsaw 10 may include a guide bar 12. Guide bar 12 may include an outer track 14. Chainsaw 10 may further include a chain 16 which is movably coupled to the guide bar 12, such as to the outer track 14 thereof. The chain 16 may include teeth which, when moved along the guide bar 12, cause the chain to cut into material, such as logs and branches. During operation of the chainsaw 10, the chain 16 may move along the outer track 14 to cause such cutting. Such movement may be caused by a motive device 40, which drives the chain.

As will be explained in greater detail, the chainsaw 10 generally includes a housing 20 that defines an interior 22. For instance, a rigid chassis 18 and one or more shell panels 24 attached to the rigid chassis 18 may form a main housing portion 26 within which (e.g., between the rigid chassis 18 and the one or more shell panels 24) the interior 22 is defined. Generally, the rigid chassis 18 provides a metal (e.g., steel, aluminum, or copper—including alloys thereof) body while the shell panels 24 each provide a relatively flexible plastic or polymer body that can be joined to the rigid chassis 18. The guide bar 12 can extend from the main housing portion 26, such that at least a portion (e.g. an end portion) of the guide bar 12 attaches to the housing 20. For example, housing 20 can include a guide bar cover portion 27 which is connected to the main housing portion 26. The guide bar 12 can extend between the main housing portion 26 and the guide bar cover portion 27 such that the end portion of the guide bar 12 is covered. A fastener assembly 28, which may for example include bolts, screws, or other suitable hardware, may affix the guide bar 12 to the housing 20, such as to the guide bar cover portion 27 or the main housing portion 26.

The chainsaw 10 can further include a motive device 40, such as an electric motor or gas powered engine. In some exemplary embodiments, at least a portion of the motive device 40, such as the entire motive device 40, is disposed in the interior 22, such as within the main housing portion 26. The motive device 40 may be operable to move the chain 16 relative to the guide bar 12. For example, the motive device 40 may drive a chain sprocket 42. The chain sprocket 42 can be engaged with the chain 16 such that rotation of the chain sprocket 42 causes the chain 16 to move relative to the guide bar 12. The motive device 40 can be powered, for example, by a rechargeable energy source such as a battery pack 100 as shown.

The chainsaw 10 may further include an actuator 50. The actuator 50, such as a rotatable or depressible trigger, may be disposed proximate to (such as in some embodiments at least partially housed in) a handle, such as primary handle 30 or secondary handle 32. When depressed, the actuator can engage the motive device 40 to cause the chain 16 to move. In optional embodiments, as the actuator 50 is depressed further, a speed of the motive device 40 can increase from zero speed to a maximum speed. In this regard, the actuator 50 may variably affect the speed of the motive device 40 between a stopped speed, which occurs when the actuator 50 is not depressed, and a maximum speed, which occurs when the actuator 50 is fully depressed.

The chainsaw 10 may further include a lockout switch 52. The lockout switch 52, which may be rotatable or depressible, may be disposed proximate to (such as in some embodiments partially housed in) a handle, such as primary handle 30 or secondary handle 32. In some embodiments, lockout switch 52 may be disposed on the same handle as actuator 50, such as on an opposite side of the handle from actuator 50. Lockout switch 52 may be a safety mechanism that prevents operation of the chainsaw 10 unless the switch 52 is activated by an operator. Thus, if actuator 50 is actuated but lockout switch 52 is not actuated, the chainsaw 10 may not operate. If lockout switch 52 is actuated, then chainsaw 10 may operate upon actuation of the actuator 50.

The brake 34 can be positioned along the chainsaw 10 at a location, for example, adjacent to the primary handle 30. The brake 34 can provide safety braking which prevents the chainsaw 10 from kicking back onto the operator with the chain 16 moving. Upon occurrence of kickback, the brake 34 can be activated by hitting the operator's arm, thereby causing the chain 16 to abruptly slow down or stop. As shown, the brake 34 may be disposed within the interior 22 (e.g., forward from a battery interface 120).

In some embodiments, the chainsaw may further include a controller 60, such as a printed circuit board. The controller 60 may be operatively connected to, and may control or be controlled by, the actuator 50, lockout switch 52, battery pack 100, or motive device 40.

As shown, an orthogonal coordinate system may be defined for the chainsaw 10, and may include a longitudinal direction G, a lateral direction L, and a vertical direction V, all of which may be mutually orthogonal to each other. As shown, guide bar 12 may extend from housing 20 along the longitudinal direction G or otherwise define the same.

As noted above, housing 20, and in particular main housing portion 26, includes a rigid chassis 18 (e.g., as or as part of a chassis core 80) and one or more shell panels 24. When assembled, the one or more shell panels 24 attach to the rigid chassis 18 (e.g., via one or more mechanical fasteners, such as screws, bolts, nuts, clips, etc.) such that the interior 22 is defined as an enclosed cavity. As shown, opposite of the interior 22, the shell panels 24 may define at least a portion of the outer or exterior surface of the chainsaw 10. In some embodiments, at least a portion of the chassis core 80 is provided within the interior 22. For instance, as shown, the shell panels 24 may cover the chassis core 80.

In the illustrated embodiments, the shell panels 24 include a first lateral panel and a second lateral panel that join to and cover at least a portion of the rigid chassis 18 (or chassis core 80 generally). At least a portion of the shell panels 24 may be disposed above the rigid chassis 18. In some such embodiments, the panels 24 define a handle (e.g., above the rigid chassis 18). For instance, the first lateral panel and the second lateral panel may join together (e.g., as two clamshell panels 24) with separable segments that together form primary handle 30. A handle cavity may be defined between the panels 24 and, thus, provide a chamber within which at least a portion of the actuator 50 may be housed. In additional or alternative embodiments, a secondary handle 32 attaches to and extends about a portion of the primary housing 26. For instance, the secondary handle 32 may extend arcuately between a first end (e.g., joined to the primary handle 30) and a second end (e.g., joined to a lower portion of the housing 20, such as at the first lateral panel).

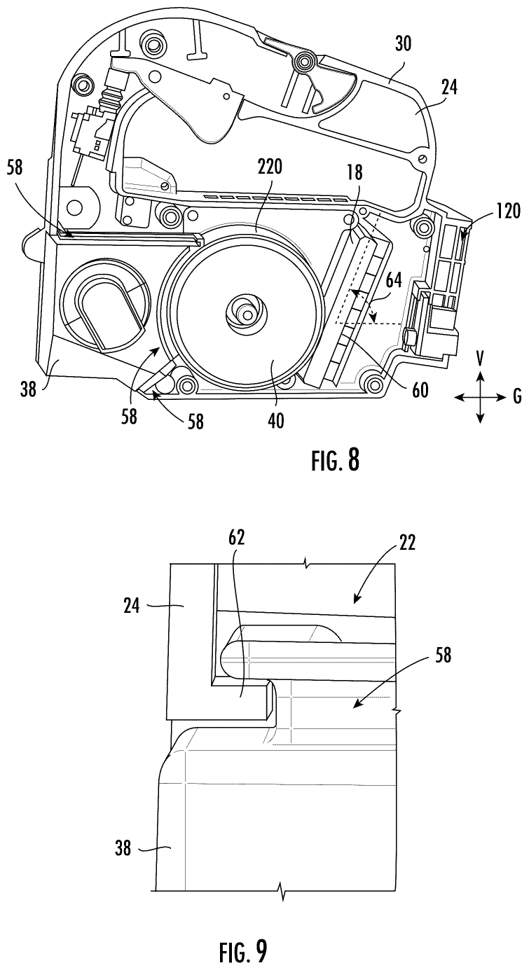

Generally, a lubrication system including an oil tank 38 may be provided on the primary housing 26. The oil tank 38 may define a tank volume 44 within which a lubricant may be received and which may fluidly connect to a lubricant pump 46 (e.g., housed within interior 22, such as on or within the rigid chassis 18). In some embodiments, the oil tank 38 is positioned forward from the motive device 40 (e.g., along the longitudinal direction G). Moreover, the oil tank 38 may be positioned opposite from the guide bar 12 (e.g., along the lateral direction L). Optionally, at least a portion of the oil tank 38 may be exposed to the ambient environment (e.g., outside of the interior 22). For instance, the oil tank 38 may define an exposed outer or exterior surface disposed outside of the housing 20 (e.g., opposite of the tank volume 44). Thus, at least a portion of the oil tank 38 wall (e.g., which defines the tank volume 44) may form an outer or exterior surface of the chainsaw 10. The outer surface of the oil tank 38 may be flush with an outer surface of the shell panels 24. In certain embodiments, the oil tank 38 defines a negative channel or perimeter groove 58 that is disposed proximal to the shell panels 24. The perimeter groove 58 may be complementary to a mating lip 62 formed on the shell panel 24 (e.g., proximal to the oil tank 38). As shown, especially in FIGS. 8 and 9, the mating lip 62 may be received within the perimeter groove 58, thereby restricting movement of the oil tank 38 relative to the main housing portion 26 and, in some cases, preventing the ingress of moisture to the interior 22. Notably, significant weight savings may be achieved (e.g., in comparison to existing designs) without sacrificing structural integrity.

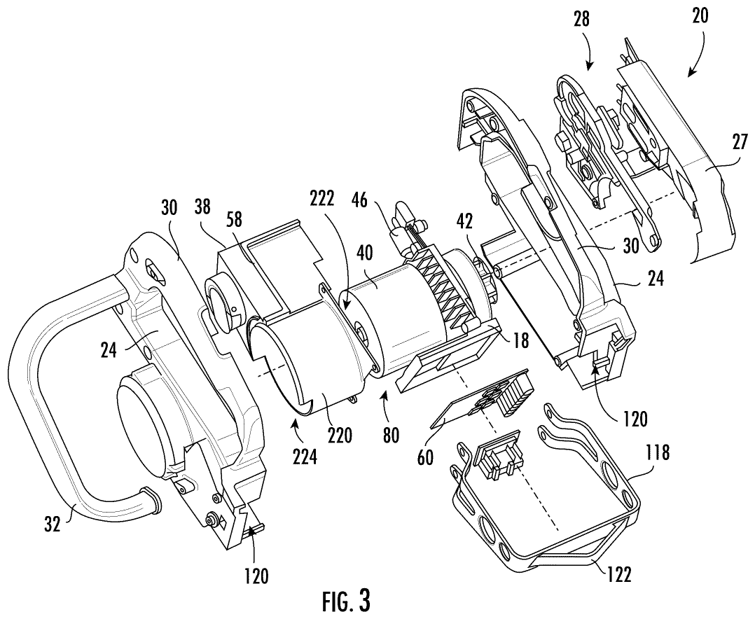

Turning especially to FIGS. 3, 16, and 17, within the interior 22, lubricant pump 46 may fluidly couple to oil tank 38 (e.g., via one or more hoses). When assembled, the lubricant pump 46 is generally upstream from the tank volume 44. Downstream of the pump 46, the pump 46 may further fluidly couple (e.g., via another hose) to an output configured to dispense the lubricant adjacent to the chain so as to lubricate the chain. The pump 46 can draw lubricant from the tank 38 via a lubricant inlet 380 and deliver lubricant through a lubricant outlet 382 to provide the lubricant at a location adjacent to the chain 16 (FIG. 1).

In some embodiments, pump 46 is in mechanical communication with (e.g., to be driven by) the motive device 40. For instance, pump 46 may be in mechanical communication with the same motive device 40 driving rotation of the chain 14 or a fan 216. In certain embodiments, the pump 46 connects to the motor shaft of the motive device 40 opposite of the fan 216. As illustrated, a piston 360 further may include a gear 370 configured to operably couple with the motor shaft to cause reciprocal movement of the piston 360 along a longitudinal direction G. The present figures illustrate a pump 46 having a mid-gear style piston 360. In this arrangement, the gear 370 is disposed along the piston 360 at a position between an inclined surface at a second end and a cut-out portion at a first end. However, the present invention contemplates any suitable style of pump or gear assembly.

Turning to FIGS. 1 through 4 and 22 through 25, a battery pack 100 may be removably received on the main housing 26. Battery pack 100 may be operatively connected to, and may provide power to, the chainsaw 10, such as the motive device 40, when connected to the chainsaw 10. Battery pack 100 may be removably coupled to the chainsaw 10 to provide such power, such as removably coupled to the housing 20. For example, chainsaw 10 may further include a battery interface 120 (e.g., disposed at a rear end of housing 20, opposite of the guide bar 12, which extends from a front end of the housing 20). Battery pack 100 may be removably coupled to the chainsaw 10 through the battery interface 120. When the battery pack 100 is coupled to the battery interface 120, power from the battery pack 100 may be provided through the battery interface 120 to the motive device 40.

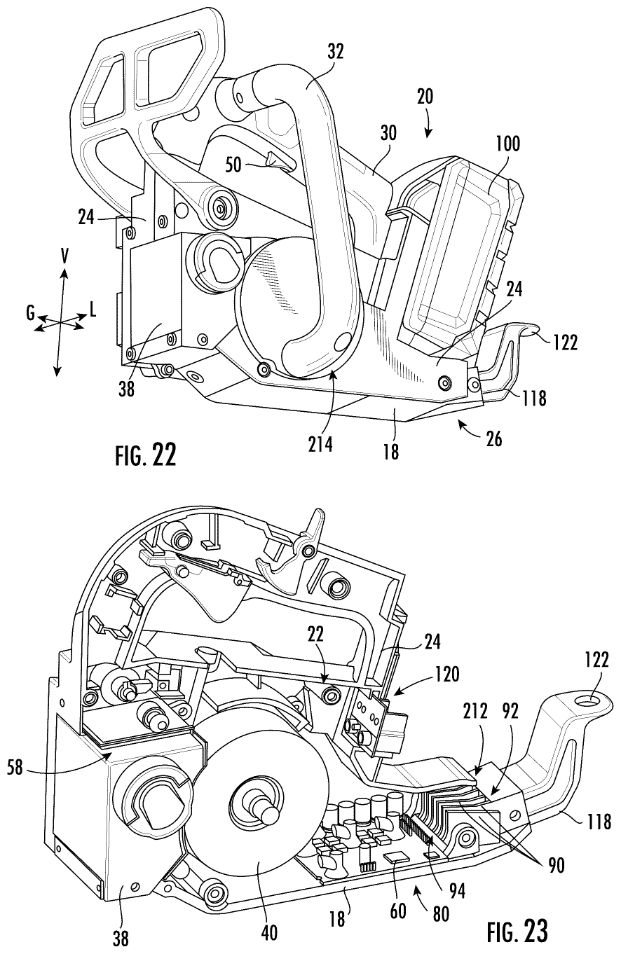

At the rear end of the housing 20 a battery guard 118 may be mounted. For instance, as shown in FIGS. 1 through 6, the battery guard 118 may be formed as a C-shaped rail extending about the battery interface and which attaches to opposite lateral panels of main housing portion 26. A tether hook 122 may be formed on the guard at a laterally central location (e.g., at a common height along the vertical direction V) to align with the center of gravity of chainsaw 10. In alternative embodiments, such as those shown in FIGS. 22 through 25, the battery guard 118 may be formed as longitudinally extending, L-shaped rail attached to the chassis core 80 and extending rearward therefrom. In particular, the L-shaped rail may extend from a location below the battery interface 120 to a free end that is disposed at a common height along the vertical direction V with at least a portion of the battery interface 120. When assembled, a tether hook 122 formed at the free end may thus be provided in line with at least a portion of the battery pack 100.

Returning generally to FIGS. 1 through 25, the motive device 40 may be supported on the rigid chassis 18 (e.g., as part of the chassis core 80) within the interior 22. As shown, the rigid chassis 18 itself may include a vertical plate 82 against which the motive device 40 is mounted (e.g., via one or more mechanical fasteners). In some such embodiments, a shaft aperture 86 is defined (e.g., along the lateral direction L) through the vertical plate 82 to receive the driveshaft of the motive device 40. When assembled, the motive device 40 may thus be disposed on one lateral side of the vertical plate 82 while the driveshaft extends through the vertical plate 82 to the opposite lateral side to connect to the chain sprocket 42. Optionally, a support column 88 may extend from the vertical plate 82 (e.g., about the shaft aperture 86 and opposite of the chain sprocket 42) to further support the motive device 40 within the interior 22. Notably, the chain sprocket 42 may be directly driven by the motive device 40, thereby eliminating the need for inefficient gearing or gearbox arrangements. Additionally or alternatively, a relatively compact, ergonomic, or efficient configuration of main housing 26 may be achieved (e.g., in comparison to existing designs).

Separate from or in addition to the motive device 40, in some embodiments, the rigid chassis 18 supports the control board 60. Specifically, the rigid chassis 18 may support the control board 60 (e.g., one or more printed circuit boards thereof) apart from the motive device 40. Thus, the control board 60 may be out of contact with the motive device 40. In some such embodiments, the rigid chassis 18 includes a board plate 84 against which the control board 60 is mounted. As shown, the board plate 84 may be positioned at an angle (e.g., perpendicular relative to) the vertical plate 82. For instance, the board plate 84 may extend laterally from the vertical plate 82 (e.g., opposite of the chain sprocket 42) and overlap with at least a portion of the lateral width of the motive device 40. Notably, heat transfer from control board 60 may promoted (e.g., even when active airflow is not present).

When assembled, the control board 60 may be disposed rearward from the motive device 40. For instance, turning especially to FIGS. 8 through 21, the control board 60 may be disposed rearward from the motive device 40 at a non-parallel and non-orthogonal angle 64 relative to the longitudinal direction G. In some embodiments, the angle 64 is defined by or similarly followed by the board plate 84. The angle 64 may be a downward angle from a rear end towards a front end surface along the longitudinal direction G. In exemplary embodiments, the angle 64 may be between 5 degrees and 65, between 10 degrees and 20 degrees, between 40 degrees and 60 degrees, such as between 45 degrees and 55 degrees, such as between 48 degrees and 52 degrees.

In alternative embodiments, such as those illustrated in FIGS. 22 through 25, the control board 60 is disposed rearward from the motive device 40 and is parallel to the longitudinal direction G. As shown, the board plate 84 may be formed as a base plate of the main housing 26 and provide a support surface for the control board 60. Thus, the control board 60 may be mounted to a bottom portion of the interior 22 (e.g., below the motive device 40).

Returning generally to FIGS. 1 through 25, an airflow path may be defined through interior 22. In particular, airflow path may be defined from an air intake 212 upstream from the interior 22 to an air exhaust 214 downstream from the interior 22. In some embodiments, one or both of air intake 212 and air exhaust 214 may be defined through housing 20. The board plate 84 in particular (e.g., on which the one or more of the printed circuit boards 60 is mounted) may be disposed along the airflow path.

In some such embodiments, the rigid chassis 18 comprises a plurality of heat-sink fins 90 (e.g., spaced apart from the control board 60) and defining one or more air channels within the interior 22 along the airflow path. The heat-sink fins 90 may specifically define a channel inlet 92 and a channel outlet 94 within the interior 22. The channel inlet 92 may be defined, for instance upstream from the control board 60 or motive device 40. For instance, the channel inlet 92 may be defined at the air intake 212. The air intake 212 may be defined between a portion of one or more shell panels 24 and the heat-sink fins 90. Downstream from the channel inlet 92, the channel outlet 94 may be defined within the interior 22 upstream from the motive device 40. The heat-sink fins 90 may extend toward the motive device 40 from the channel inlet 92 to the channel outlet 94. Notably, swirling or disordered airflow within the interior 22 may be prevented.

Returning briefly to FIGS. 8 through 21, the heat-sink fins 90 may extend from the vertical plate 82 laterally and opposite of the chain sprocket 42. As shown, the heat-sink fins 90 may further be disposed above the motive device 40. In turn, air may flow downward along the airflow path and air channels to the motive device 40. The heat-sink fins 90 may, additionally or alternatively, be disposed forward from the control board 60 or board plate 84. In some embodiments, the control board 60 is mounted on a rear surface of the board plate 84. Air may thus flow along the airflow path and a front face of the board plate 84, facilitating convective heat transfer for heat conducted away from the control board 60 through the board plate 84.

Alternatively, and as illustrated in FIGS. 22 through 22, the heat-sink fins 90 may extend upward from the board plate 84. As shown, the heat-sink fins 90 may further be disposed below the motive device 40. In turn, air may flow forward along the airflow path and air channels to the motive device 40. The heat-sink fins 90 may, additionally or alternatively, be disposed rearward and upstream from the control board 60. The control board 60 may be disposed upstream from the motive device 40. In turn, air may flow forward and across the heat-sink fins 90 before flowing across the control board 60 and then to the motive device 40. In optional embodiments, one or more exterior fins are further provided (e.g., extending downward from a bottom surface of the board plate 84. In turn, further heat transfer may be promoted through the rigid chassis 18 to the ambient environment.

Returning generally to FIGS. 1 through 25, air intake 212 may be defined at a rearward or back half of housing 20. For instance, air intake 212 may be generally defined as one or more openings provided at a rear end of housing 20. Downstream from the interior 22, air exhaust 214 may be defined (e.g., through one or more shell panels 24). In some embodiments, the air exhaust 214 being defined forward from the air intake 212. Thus, relative to the longitudinal direction G, the air exhaust 214 may be defined at a location closer to the front end than air intake 212. Optionally, air exhaust 214 may be defined below at least a portion of the motive device 40. As shown, air exhaust 214 may be directed downward or rearward (e.g., to direct air below housing 20 or rearward, away from guide bar 12).

As shown, a fan 216 (e.g., radial fan, tangential fan, or impeller) having one or more air blades may be mounted within the housing 20 (e.g., along the airflow path) to generate or motivate the airflow from the air intake 212 to the air exhaust 214. In some such embodiments, the fan 216 is mounted on or in mechanical communication the motive device 40. For instance, the fan 216 may be mounted to the motive device 40 opposite of the chain sprocket 42 within interior 22 (e.g., relative to the lateral direction L). In turn, rotation of the chain may simultaneously rotate the fan 216 to generate the airflow through interior 22.

In optional embodiments, a sub-enclosure shroud 220 is disposed within the interior 22. Specifically, the sub-enclosure shroud 220 through which a portion of the airflow path is defined. As shown, the sub-enclosure 220 may house one or more components, such as the fan 216 or a portion of the motive device 40. A curved inner wall of the sub-enclosure 220 may be wrapped around at least a portion of the fan 216 or motive device 40. In some embodiments, the oil tank 38 includes or further forms the sub-enclosure shroud 220 with a shroud body that extends rearward from the tank volume 44 about the motive device 40 within the interior 22.

As shown, the sub-enclosure 220 may define an enclosure intake 222 and an enclosure exhaust 224. The enclosure intake 222 may be defined, for instance, along the lateral direction L (e.g., against the vertical plate 82 or plurality of heat-sink fins 90). Additionally or alternatively, the enclosure exhaust 224 may be defined, for instance along the vertical direction V or otherwise directed toward the air exhaust 214 (e.g., as a circumferential notch or cut-out from a portion of the sub-enclosure shroud 220 surrounding the motive device 40). Optionally, the enclosure exhaust 224 may be defined at a lower position relative to the vertical direction V than the enclosure intake 222 (e.g., directly above the air exhaust 214).

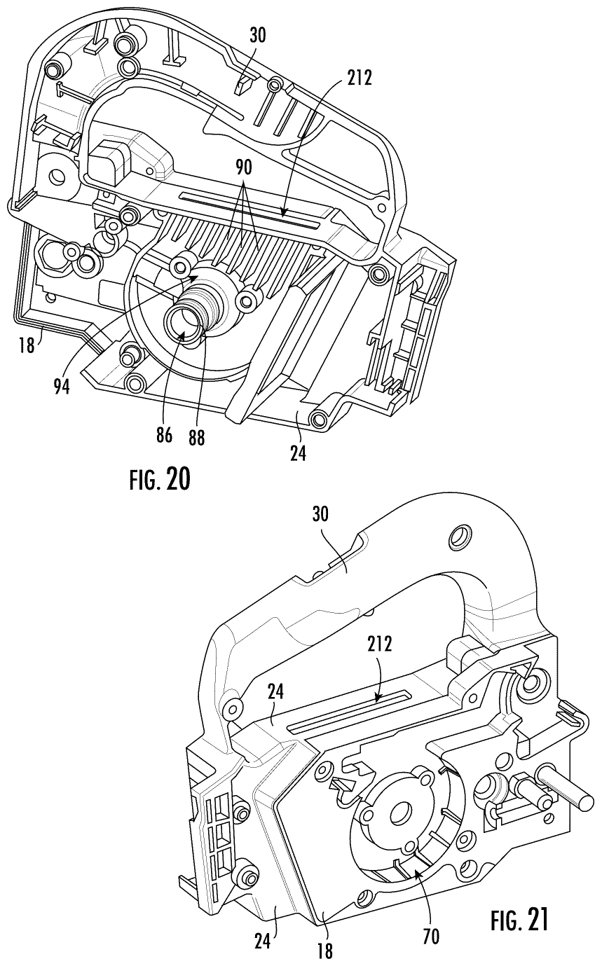

Turning briefly to FIGS. 20 and 21, along with supporting the motive device 40 or control board 60, some embodiments of the chainsaw 10 may include the guide bar 12 supported on the rigid chassis 18. For instance, opposite of the motive device 40, the guide bar 12 may be mounted on a lateral face of the rigid chassis 18. Optionally, a brake recess 70 may be defined on the same lateral face to receive at least a portion of the brake 34, notably providing element mounting support without requiring additional components.

Further aspects of the disclosure are provided by one or more of the following embodiments:

Embodiment 1. A chainsaw comprising: a housing comprising a rigid chassis and one or more shell panels attached to the rigid chassis, the housing defining an interior between the rigid chassis and the one or more shell panels; a guide bar attached to the housing, the guide bar comprising an outer track; a chain movably coupled to the outer track; and a motive device operable to move the chain relative to the guide bar, the motive device being supported on the rigid chassis within the interior.

Embodiment 2. The chainsaw of any one or more of the embodiments, wherein the one or more shell panels define a handle disposed above the rigid chassis.

Embodiment 3. The chainsaw of any one or more of the embodiments, further comprising a movable actuator disposed on the handle.

Embodiment 4. The chainsaw of any one or more of the embodiments, further comprising an oil tank defining a tank volume and mounted to the housing forward from motive device.

Embodiment 5. The chainsaw of any one or more of the embodiments, wherein the oil tank defines an exposed outer surface disposed outside of the housing and opposite of the tank volume.

Embodiment 6. The chainsaw of any one or more of the embodiments, wherein the oil tank defines a tank volume to receive a lubricant therein, and wherein the oil tank further comprises a shroud body extending rearward from the tank volume about the motive device within the interior.

Embodiment 7. The chainsaw of any one or more of the embodiments, further comprising a battery pack removably received at a rear end of the housing opposite of the guide bar at a front end of the housing.

Embodiment 8. The chainsaw of any one or more of the embodiments, further comprising a control board supported on the rigid chassis apart from the motive device.

Embodiment 9. The chainsaw of any one or more of the embodiments, wherein the control board is disposed rearward from the motive device at a non-parallel and non-orthogonal angle relative to a longitudinal direction defined by the guide bar.

Embodiment 10. The chainsaw of any one or more of the embodiments, wherein the rigid chassis comprises a plurality of heat-sink fins defining one or more air channels within the interior.

Embodiment 11. The chainsaw of any one or more of the embodiments, wherein the plurality of heat-sink fins define a channel inlet and a channel outlet disposed below the channel inlet.

Embodiment 12. The chainsaw of any one or more of the embodiments, wherein the guide bar is supported on the rigid chassis.

Embodiment 13. A chainsaw comprising: a housing comprising a rigid chassis and one or more shell panels attached to the rigid chassis, the housing defining an interior between the rigid chassis and the one or more shell panels; a guide bar attached to the housing, the guide bar comprising an outer track; a chain movably coupled to the outer track; a motive device operable to move the chain relative to the guide bar, the motive device being supported on the rigid chassis within the interior; and a control board supported on the rigid chassis rearward from the motive device, wherein the rigid chassis comprises a plurality of heat-sink fins defining one or more air channels extending downward and toward the motive device from a channel inlet to a channel outlet.

Embodiment 14. The chainsaw of any one or more of the embodiments, wherein the one or more shell panels define a handle disposed above the rigid chassis.

Embodiment 15. The chainsaw of any one or more of the embodiments, further comprising a movable actuator disposed on the handle.

Embodiment 16. The chainsaw of any one or more of the embodiments, further comprising an oil tank defining a tank volume and mounted to the housing forward from motive device.

Embodiment 17. The chainsaw of any one or more of the embodiments, wherein the oil tank defines an exposed outer surface disposed outside of the housing and opposite of the tank volume.

Embodiment 18. The chainsaw of any one or more of the embodiments, wherein the oil tank defines a tank volume to receive a lubricant therein, and wherein the oil tank further comprises a shroud body extending rearward from the tank volume about the motive device within the interior.

Embodiment 19. The chainsaw of any one or more of the embodiments, further comprising a battery pack removably received at a rear end of the housing opposite of the guide bar at a front end of the housing.

Embodiment 20. The chainsaw of any one or more of the embodiments, wherein the guide bar is supported on the rigid chassis.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural clements that do not differ from the literal language of the claims, or if they include equivalent structural clements with insubstantial differences from the literal language of the claims.

What is claimed is:

1. A chainsaw comprising:
a housing comprising a rigid chassis and one or more shell panels attached to the rigid chassis, the housing defining an interior between the rigid chassis and the one or more shell panels;
a guide bar attached to the housing, the guide bar comprising an outer track;
a chain movably coupled to the outer track; and
a motive device operable to move the chain relative to the guide bar, the motive device being supported on the rigid chassis within the interior.

2. The chainsaw of claim 1, wherein the one or more shell panels define a handle disposed above the rigid chassis.

3. The chainsaw of claim 2, further comprising a movable actuator disposed on the handle.

4. The chainsaw of claim 1, further comprising an oil tank defining a tank volume and mounted to the housing forward from motive device.

5. The chainsaw of claim 4, wherein the oil tank defines an exposed outer surface disposed outside of the housing and opposite of the tank volume.

6. The chainsaw of claim 5, wherein the oil tank defines a tank volume to receive a lubricant therein, and wherein the oil tank further comprises a shroud body extending rearward from the tank volume about the motive device within the interior.

7. The chainsaw of claim 1, further comprising a battery pack removably received at a rear end of the housing opposite of the guide bar at a front end of the housing.

8. The chainsaw of claim 1, further comprising a control board supported on the rigid chassis apart from the motive device.

9. The chainsaw of claim 8, wherein the control board is disposed rearward from the motive device at a non-parallel and non-orthogonal angle relative to a longitudinal direction defined by the guide bar.

10. The chainsaw of claim 1, wherein the rigid chassis comprises a plurality of heat-sink fins defining one or more air channels within the interior.

11. The chainsaw of claim 10, wherein the plurality of heat-sink fins define a channel inlet and a channel outlet disposed below the channel inlet.

12. The chainsaw of claim 1, wherein the guide bar is supported on the rigid chassis.

13. A chainsaw comprising:
a housing comprising a rigid chassis and one or more shell panels attached to the rigid chassis, the housing defining an interior between the rigid chassis and the one or more shell panels;
a guide bar attached to the housing, the guide bar comprising an outer track;
a chain movably coupled to the outer track;
a motive device operable to move the chain relative to the guide bar, the motive device being supported on the rigid chassis within the interior; and
a control board supported on the rigid chassis rearward from the motive device,
wherein the rigid chassis comprises a plurality of heat-sink fins defining one or more air channels extending downward and toward the motive device from a channel inlet to a channel outlet.

14. The chainsaw of claim 13, wherein the one or more shell panels define a handle disposed above the rigid chassis.

15. The chainsaw of claim 14, further comprising a movable actuator disposed on the handle.

16. The chainsaw of claim 13, further comprising an oil tank defining a tank volume and mounted to the housing forward from motive device.

17. The chainsaw of claim 16, wherein the oil tank defines an exposed outer surface disposed outside of the housing and opposite of the tank volume.

18. The chainsaw of claim 16, wherein the oil tank defines a tank volume to receive a lubricant therein, and wherein the oil tank further comprises a shroud body extending rearward from the tank volume about the motive device within the interior.

19. The chainsaw of claim 13, further comprising a battery pack removably received at a rear end of the housing opposite of the guide bar at a front end of the housing.

20. The chainsaw of claim 13, wherein the guide bar is supported on the rigid chassis.
